(19) United States
(12) Patent Application Publication
(10) Pub. No.: US 2009/0154986 A1
(43) Pub. Date: Jun. 18, 2009

(54) COMBINATION READING TOOL

(76) Inventor: Carl Cetera, Tenafly, NJ (US)

Correspondence Address: THE SONI LAW FIRM, 35 North Lake Ave., Suite 720, PASADENA, CA, 91101, US

(21) Appl. No.: 11/957,989

(22) Filed: Dec. 17, 2007

(51) Int. Cl. B43K 29/00

(52) U.S. Cl. 401/195

(57) ABSTRACT

A combination reading tool integrating a magnifying glass, a highlighting marker, and a tape flag dispenser in a compact unit. The combination reading tool has a handheld, ergonomically contoured, portable housing with a window defined between two opposing planar surfaces, a magnifying glass fitted in the window, and a writing instrument such as a highlighter disposed within the housing with its tip extended from a side surface of the housing. The writing instrument is preferably integrally formed with the housing, but in another embodiment, may be removably disposed therein. The housing may further have a recess on one of the two opposing surfaces for storing flag tapes therein with a removable lid thereon. Also, advertising material may be disposed on an outer surface of the housing unoccupied by the magnifying glass.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND OF THE INVENTION

The present invention relates to the field of a combination reading tool with a magnifying glass, a highlighter or a marker, and a tape flag dispenser integrated in a compact, handheld body.

When reading books, magazines, newspapers, or other printed publications, people commonly need to mark passages by a marker or highlighter, or mark pages by a flag tapes for quick reference later on. Often people need to use a magnifying glass as well to aid weakened eyesight. Therefore, if such widely used reading tools are assorted and effectively combined in a single handheld device, it would help greatly for reading.

Some attempts to combine two or more such reading tools have been made in the art. U.S. Pat. No. 5,309,643 discloses a collar-shaped adapter having a pivotally foldable rectangular magnifying glass where the adapter can be removably and slidably attached around the barrel of a highlighter for magnifying fine prints during reading. US Patent Application No. 2004/0234326 discloses a typical highlighter where a removable tape flag dispenser is incorporated into either its cylindrical barrel or tip cap. Similarly, US Patent Application No. 2005/0191114 discloses a tape flag dispenser inserted into a compartment defined in the barrel of a highlighter. U.S. Pat. No. 6,941,604 and U.S. Pat. No. 6,874,189 disclose a ‘Swiss Army Knife’ type handheld device having multiple utilities, including a magnifying glass capable of being pushed in and out of a compartment, and a retractable roll-up tape contained in another compartment.

None of the prior art inventions teaches the combination of the three aforementioned frequently used reading tools: a highlighter, a flag tape dispenser, and a magnifying glass. Further, in the above-identified prior art, it appears that the magnifying glass, when in need of use, needs to be rotated, unfolded, retracted out of a compartment, or mechanically moved in other ways by a user. This makes it somewhat cumbersome for a user to readily use it.

Therefore, it is desirable to provide a combination reading tool that integrates the most frequently used reading aids such as a highlighter, a flag tape dispenser, and a magnifying glass in a compact and handheld unit to help easy and convenient reading. It is further desirable that in such a combination reading tool, the magnifying glass is designed such that it can be readily used without having to be removed from or moved within the housing before use.

### SUMMARY OF THE INVENTION

In accordance with a preferred embodiment of the present invention, there is provided a combination reading tool including a magnifying glass, a highlighting marker, and a tape flag dispenser integrated in a compact, handheld body.

The combination reading tool made in accordance with the present invention is largely comprised of: in the preferred embodiment, a handheld ergonomically contoured portable housing, a magnifying glass, and a writing instrument. The housing has substantially planar opposing front and rear surfaces and side surfaces contiguous thereto, and defines a window extending between the front and rear surfaces. The magnifying glass is sized and configured to fixedly fit within the window. The writing instrument such as a highlighting marker is disposed within the housing where its tip is extended from one of the sides of the housing. In one embodiment, the tip may be retractable and in another, be non-retractable with a protecting cap thereon. In the preferred embodiment, the writing instrument may be integrally formed with the housing so that it is non-removable. But in another embodiment, the writing instrument may be removably fitted within a lengthy hollow defined within the housing. Further, the combination tool can have flag tapes stored in a recess formed on one of the front and rear surfaces of the housing and an openable lid may cover the recess.

The combination may also have advertising material or indicia imprinted on the outer surface not occupied by the magnifying glass.

One of the advantages of the present invention is that having the most frequently and widely used reading aids such as a highlighter, a flag tape dispenser, and a magnifying glass integrated into a single compact and ergonomically contoured portable unit, the combination tool is, while easy to carry, an excellent assistant in reading, especially for elders.

Another advantage of the present invention is that since the magnifying glass, and preferably the highlighter as well, are fixedly fitted with the tool housing, a user can readily and conveniently use them without having to remove them from the housing before use and reinstall them after use as is the case with other prior, similar inventions.

### BRIEF DESCRIPTION OF THE DRAWINGS

FIG. 1 illustrates a perspective view of the combination reading tool made in the preferred embodiment of the present invention with a marker protection cap on;

FIG. 2 illustrates a perspective view of the combination reading tool made in the preferred embodiment of the present invention with the marker protection cap off, showing an opposite side of the tool depicted in FIG. 1;

FIG. 3 illustrates a perspective view of the combination reading tool made in the preferred embodiment of the present invention, showing an exemplary way of using the tool, particularly, the magnifying glass;

FIG. 4 illustrates a perspective view of the combination reading tool made in the preferred embodiment of the present invention, showing another exemplary way of using the magnifying glass;

FIG. 5 illustrates a perspective view of the combination reading tool made in the preferred embodiment of the present invention, with an exploded view of the flag tape dispenser;

FIG. 6 illustrates a perspective view of the combination reading tool made in the preferred embodiment of the present invention, showing an exemplary way of using the tool, particularly, the highlighting marker;

FIG. 7 illustrates a cross-sectional side elevational view of the combination reading tool made in the preferred embodiment of the present invention; and

FIG. 8 illustrates an exploded view, in the perspective, of the combination reading tool made in the preferred embodiment of the present invention.

### DETAILED DESCRIPTION OF THE PREFERRED EMBODIMENT

The preferred embodiment of the present invention will now be described with reference to figures (‘FIGS.’) 1-8, wherein like components are designated by like reference numerals throughout the figures. With regard to means for fastening, mounting, attaching or connecting the components of the present invention to form the assembly as a whole, unless specifically described otherwise, such means are intended to at least encompass conventional fasteners such as machine screws, machine threads, snap rings, hose clamps, rivets, nuts and bolts, toggles, pins and the like. Components may also be connected by friction fitting, snap fitting, adhesives or by welding or deformation, if appropriate. Unless specifically otherwise disclosed or taught, materials for making components of the present invention are selected from appropriate materials such as metal, ceramics, metallic alloys, natural or synthetic fibers, plastics and the like, and appropriate manufacturing or production methods including casting, extruding, injection molding and machines may be used.

Although the present invention is generally described in terms of the preferred embodiments, it should be understood that it is shown and described, only by way of illustration of the best mode contemplated in carrying out the invention, but not intended to limit in any way the spirit and scope of the invention to the particular embodiments described.

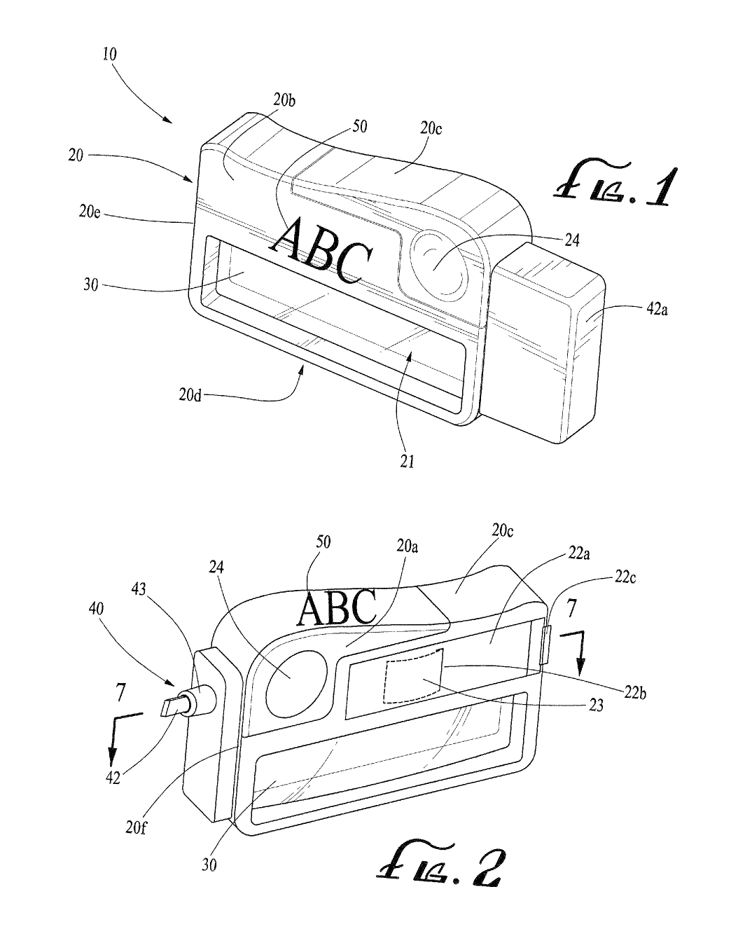

Now referring to FIG. 1-8, the combination tool 10 made in the preferred embodiment of the present invention comprises largely a tool housing 20, a magnifying glass 30, a highlighting marker 40. The tool housing 20 has a shape of a thin generally rectangular slab comprising substantially planar opposing top and bottom surfaces 20a, 20b, and generally perpendicular thereto, four side surfaces, which are upper and lower side surfaces 20c and 20d defining the longer side of the housing 20 and right and left side surfaces 20e and 20f defining the shorter side.

The tool housing 20 has a rectangular window 21 extending between the top and bottom surfaces 20a and 20b in which the magnifying glass 30 is fixedly fitted. Preferably, the rectangular window 21 is positioned on an upper half of the housing 20 closer to the lower side surface 20d with the longer side of the rectangle being parallel to the longer side of the housing 20. The function and the optical structure of magnifying glass 30 is well known in the art and not described herein further.

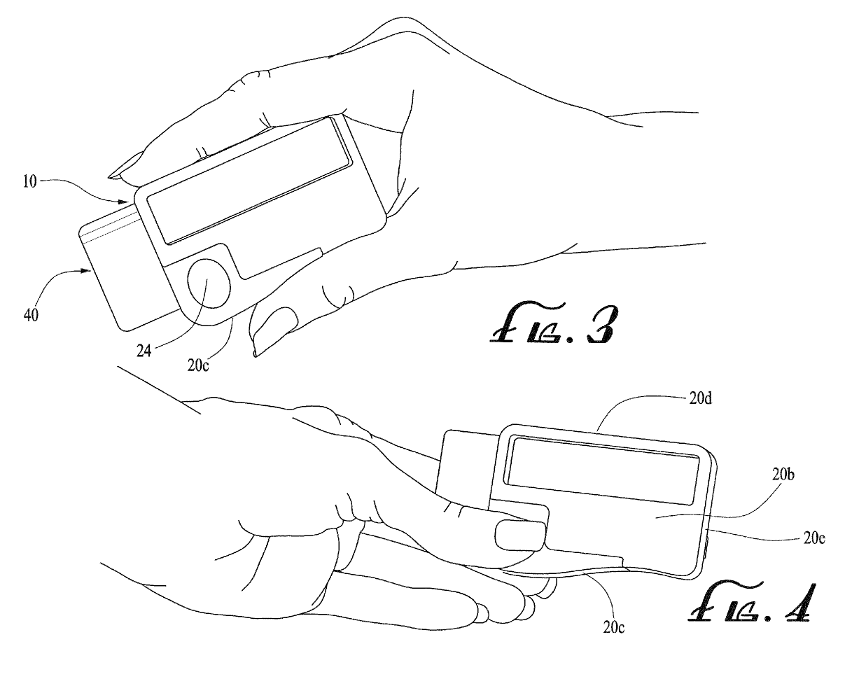

FIGS. 3, and 4 show the exemplary ways of using the combination reading tool, particularly the magnifying glass. For magnifying texts, the tool housing may be held by a user's hand in either way depicted in FIG. 3 and FIG. 4, as desired by the user. In the preferred embodiment, the upper side surface 20c is ergonomically contoured for providing comfort and stability to the user's fingers, particularly the thumb, when holding the tool in a way depicted in FIG. 3. For providing similar ergonomic comfort to a user's thumb when holding the tool in a way depicted in FIG. 4, a slight thumb dent 24 may be formed on either or both of surfaces 20a and 20b.

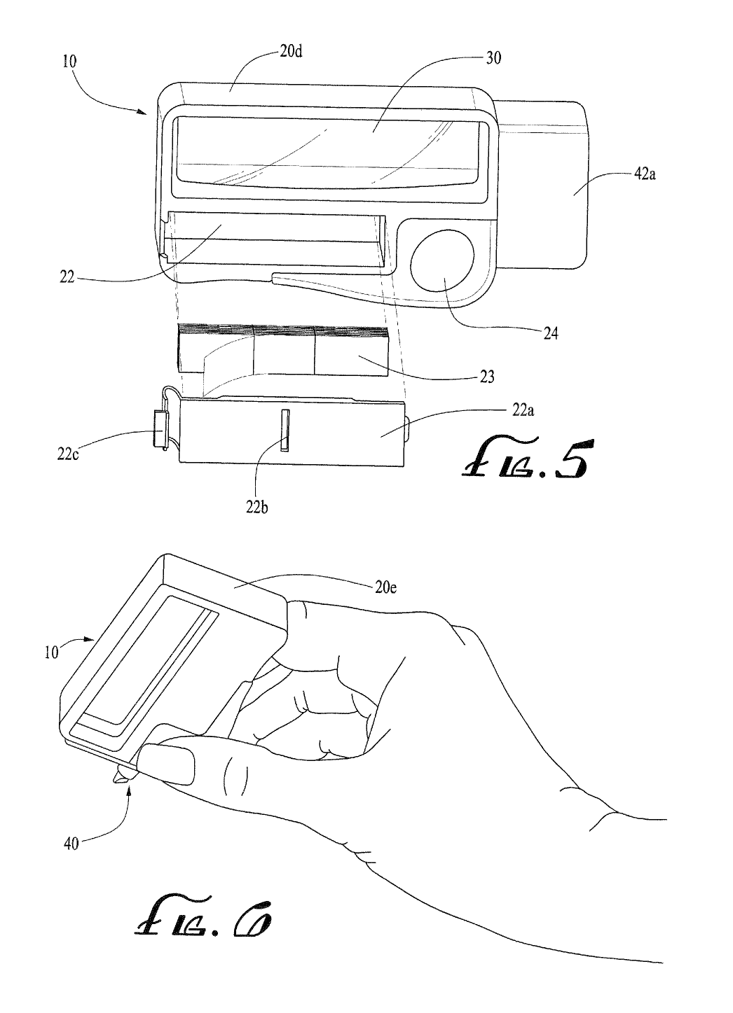

Also, the housing 20 defines a depression 22, preferably, on the upper half of the top surface 20a closer to the upper side surface 20c for storing flag tapes 23 therein as shown in FIG. 5. The depression 22 is sized and configured, preferably in a rectangular-shape, to retain flag tapes 23 of a standard type commercially available. For protection and secure retention of the flag tapes 23, a lid 22a may be disposed upon the depression 22. The lid 22a may be detachable, for instance via a finger tab 22c, or hingedly openable (not shown) for restocking the flag tapes 23 when used up. For dispensing the flag tapes, a slot 22b may be defined on the lid 22a through which a single flag may be removed one by one.

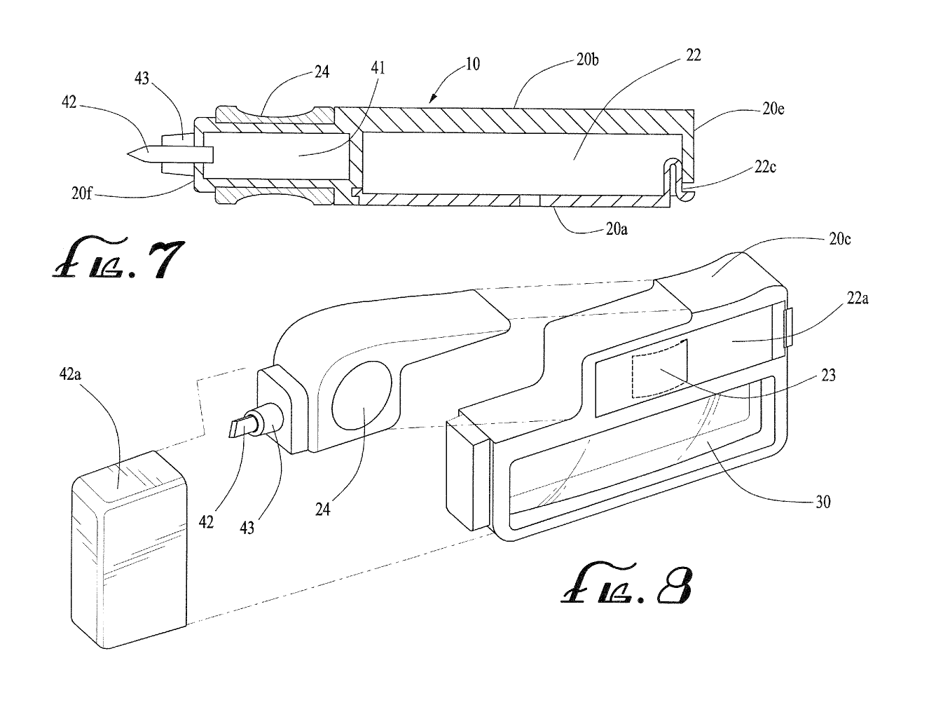

In the preferred embodiment, the highlighting marker 40 comprises a reservoir 41, shown in FIG. 7, formed within the tool housing 20 on a portion thereof unoccupied by either the window 21 or the depression 22, a highlighting or marking liquid (not shown) contained in the reservoir 41, and a marking tip 42 in fluid communication with the highlighting liquid. Such highlighting or marking liquid and marking tips are well known in the art. The marker tip 42 extends out of, preferably, a conical protrusion 43 integrally formed with the housing 20 on the side surface 20f as shown in FIGS. 2, 7, and 8. To prevent the marking tip 42 from being dried up or damaged, a tip cover 42a may be further disposed upon the marking tip 42. The tip cover 42a may be removable as shown in FIG. 8, or in another embodiment (not shown), hingedly openable with an edge thereof hingedly attached to the housing 20. FIG. 6 describes an exemplary way of holding the tool housing 20 when using the highlighting marker 40.

In another embodiment (not shown), the highlighting marker may be of a standard commercially available type having an elongated pen-shaped barrel and marker tip. In this embodiment it may be retained in a correspondingly sized and configured burrow or recess defined within the tool housing. In one embodiment, the highlighter may be configured to be removable from the housing for use or for replacement with new one. In another, the marking tip may be configured to extend securably from a side surface of the housing, like the preferred embodiment, so that the highlighter may be used while still retained in the housing.

Further, although in the preferred embodiment a highlighter is retained within the tool housing, the present invention contemplates that any kind of writing instrument instead can be incorporated with the combination tool. In one embodiment, the writing instrument, such as a ballpoint pen, may be removably retained in the housing for use. Or in another, just as in the preferred embodiment, it may be integrally formed with the tool housing itself wherein the ink is contained in a compartment integrally defined within the housing while the pen tip is fixedly protruding from a side surface of the housing.

The tool housing 20, the depression lid 22a, and the marking tip cover 42a are fabricated, preferably, from plastics, ceramics, or polymeric compositions, but may be made of any rigid suitable material known to those in the art, including but not limited to, metal, cardboard, synthetic fibers, fiberglass, hardboard, or the like, by using any appropriate manufacturing or production method such as casting, extruding, injection molding or other currently known means readily recognized by one skilled in the art.

Since the combination tool 10 would be more likely to attract attentions of the user and other viewers owing to its unique appearance and diverse utilities, it can be an effective vehicle for advertisement. For that advertising material 50 may be imprinted on either the top surface 20a, the bottom surface 20b as shown in FIG. 1, or even on any of the side surfaces of the housing 20 as shown in FIG. 2. Such advertising material may include, but not be limited to a logo, trademark, advertisement, emblem, label, stamp, feature, brand, insignia, crest, token, seal, decal, pitch, announcement, slogan, monogram. Such indicia need not be limited to letters or words, but can be also a photo, design, or other pictorial representation.

Accordingly, the present invention also includes a method of advertising using the combination reading tool made according to the invention. Such an advertising method comprises the steps of providing a desktop organizer made according to the present invention, and disposing advertising indicia on an external visible surface of the tool housing. The term “providing” has a broad meaning, including not only manufacturing but also acquiring from another source or selecting from available supplies. The term “disposing” is meant broadly to encompass any means for physically putting the advertising indicia on the surface, including but not limited to, imprinting, engraving, adhering, etc.

Additional modifications and improvements of the present invention may also be apparent to those of ordinary skill in the art. Thus, the particular combination of parts described and illustrated herein is intended to represent only certain embodiments of the present invention, and is not intended to serve as limitations of alternative devices within the spirit and scope of the invention.

1. A combination tool for magnifying and marking text, the tool comprising:
a) a handheld portable housing having substantially planar opposing front and rear surfaces and side surfaces contiguous thereto, the housing defining a window extending between the front and rear surfaces;
b) a magnifying glass sized and configured to fit within the window for viewing texts therewith; and
c) a writing instrument formed within the housing and having a tip protruding from one of the side surfaces of the housing for marking texts therewith.

2. The combination tool as in claim 1, wherein the housing further defines a recess in the front surface, sized and configured to removably store tape flags therein.

3. The combination tool as in claim 2, further comprising a removable lid covering the recess, the lid having a slit for dispensing therethrough the tape flags stored in the recess.

4. The combination tool as in claim 1, wherein the writing instrument is integrally formed with the housing.

5. The combination tool as in claim 4, further comprising a removable cap disposable over the tip.

6. The combination tool as in claim 1, wherein the window occupies at least one third of the area of each of the front and rear surfaces.

7. The combination tool as in claim 1, wherein the tip is retractable.

8. The combination tool as in claim 1, wherein at least one of the side surfaces is ergonomically contoured.

9. The combination tool as in claim 1, further comprising advertising material disposed on an outer surface of the housing.

10. A combination tool for magnifying and marking texts and dispensing tape flags therefrom, the tool comprising:
a) a handheld portable housing having substantially planar opposing front and rear surfaces and side surfaces contiguous thereto, the housing defining a window extending between the front and rear surfaces, the housing further defining a recess in the front surface sized and configured to removably store the tape flags therein;
b) a magnifying glass sized and configured to fit within the window for magnifying texts therewith; and
c) a marking instrument disposed in the housing for marking texts therewith.

11. The combination tool as in claim 10, wherein the marking instrument is integrally formed with the housing.

12. The combination tool as in claim 11, wherein the marking instrument comprises a compartment defined within the housing, marking fluid contained within the compartment, and a marking tip protruding from one of the side surfaces of the housing and being in fluid communication with the marking tip.

13. The combination tool as in claim 12, further comprising a removable cap disposable over the marking tip.

14. The combination tool as in claim 10, further comprising a removable lid covering the recess, the lid having a slit for dispensing therethrough the tape flags stored in the recess.

15. The combination tool as in claim 10, wherein the window occupies at least one third of the area of each of the front and rear surfaces.

16. The combination tool as in claim 10, wherein at least one of the side surfaces is ergonomically contoured.

17. The combination tool as in claim 10, further comprising advertising material disposed on an outer surface of the housing.

18. A method of advertising comprising the steps of:
a) providing a combination tool for magnifying and marking texts and dispensing tape flags therefrom, the tool comprising:
a handheld portable housing having substantially planar opposing front and rear surfaces and side surfaces contiguous thereto, the housing defining a window extending between the front and rear surfaces, the housing further defining a recess in the front surface sized and configured to removably store the tape flags therein,
a magnifying glass sized and configured to fit within the window for magnifying texts therewith, and
a marking instrument disposed in the housing and having a marking tip protruding from one of the side surfaces of the housing; and
b) disposing advertising material on one of the surfaces of the housing.
